(19) United States
(12) Patent Application Publication
(10) Pub. No.: US 2009/0306865 A1
(43) Pub. Date: Dec. 10, 2009

(54) AUTOMATIC TRANSMISSION AND CONTROL METHOD THEREOF

(75) Inventor: Naohiro YAMADA, Atsugi-shi (JP)

Correspondence Address: FOLEY AND LARDNER LLP;SUITE 500, 3000 K STREET NW, WASHINGTON, DC, 20007, US

(73) Assignee: JATCO Ltd

(21) Appl. No.: 12/391,515

(22) Filed: Feb. 24, 2009

(30) Foreign Application Priority Data
Mar. 7, 2008 (JP) 2008-057962

(51) Int. Cl. G06F 19/00

(52) U.S. Cl. 701/55

(57) ABSTRACT

In an automatic transmission that performs a shift on the basis of a shift map defined by a vehicle speed Vsp and a throttle opening TVO, when the vehicle speed Vsp and the throttle opening TVO exist within a 6-7 special region, which is located within a sixth speed gear position region of the shift map and defined by a downshift line at which a downshift is performed from a seventh speed gear position serving as a maximum gear position to the sixth speed gear position and a minimum vehicle speed of an upshift line at which an upshift is performed from the sixth speed gear position to the seventh speed gear position, and this condition continues for a predetermined time period, a shift is performed to the seventh speed.

### FIELD OF THE INVENTION

This invention relates to an automatic transmission.

### BACKGROUND OF THE INVENTION

When the number of gear positions increases in an automatic transmission, intervals between shift lines on a shift map become narrower, and as a result, a hunting phenomenon whereby upshifts and downshifts are performed repeatedly may occur.

To solve this problem, in JP2004-028308A of the prior art, a shift to a maximum gear position is permitted on the shift map when an accelerator depression period is equal to or longer than a predetermined time period while a vehicle condition exists within a maximum gear position region of the shift map.

Furthermore, in JP2004-028308A, a shift to the maximum gear position is permitted when variation in the return time of a throttle opening is slower than a predetermined speed during a shift from a gear position region of the shift map other than the maximum gear position to the maximum gear position region.

Hence, in JP2004-028308A, when a traveling condition in the maximum gear position region corresponds to a cruising condition or when the intention of a driver in performing a step-back operation on the accelerator pedal while in the maximum gear position region corresponds to the cruising condition, the maximum gear position is permitted.

### SUMMARY OF THE INVENTION

However, in the invention described above, a shift is performed to the maximum gear position only when the vehicle condition is in the maximum gear position region on the shift map, and therefore travel in the maximum gear position, which benefits from favorable fuel efficiency and so on, is limited, leading to problems such as an inability to improve the fuel efficiency, for example.

This invention has been invented to solve this problem, and it is an object thereof to improve fuel efficiency by performing a shift to a maximum gear position when a predetermined condition is satisfied, even if the gear position does not correspond to the maximum gear position on a shift map.

This invention provides an automatic transmission having throttle opening detecting unit for detecting a throttle opening, vehicle speed detecting unit for detecting a vehicle speed, and shift unit for performing a shift on the basis of a shift map defined by the throttle opening and the vehicle speed. The automatic transmission comprises shift map region determining unit for determining whether or not the vehicle speed and the throttle opening exist within a predetermined region provided between a downshift line at which a shift is performed from a maximum gear position of the shift map to a lower gear position than the maximum gear position and a minimum vehicle speed of an upshift line at which a shift is performed to the maximum gear position of the shift map, and cruising condition determining unit for determining whether or not an operating condition of a vehicle corresponds to a cruising condition. The shift unit performs a shift to the maximum gear position when the vehicle speed and the throttle opening are in the predetermined region and the operating condition corresponds to the cruising condition.

According to this invention, a shift is performed to the maximum gear position when the operating condition of the vehicle corresponds to the cruising condition, even if the operating condition does not correspond to the maximum gear position on the shift map, and as a result, an improvement in fuel efficiency can be achieved.

The details as well as other features and advantages of this invention are set forth in the remainder of the specification and are shown in the accompanying drawings.

### BRIEF DESCRIPTION OF THE DRAWINGS

FIG. 1 is a skeleton diagram showing an automatic transmission according to an embodiment of this invention.

FIG. 2 is a flowchart showing shift control according to an embodiment of this invention.

FIG. 3 is a shift map according to an embodiment of this invention.

### DESCRIPTION OF THE PREFERRED EMBODIMENTS

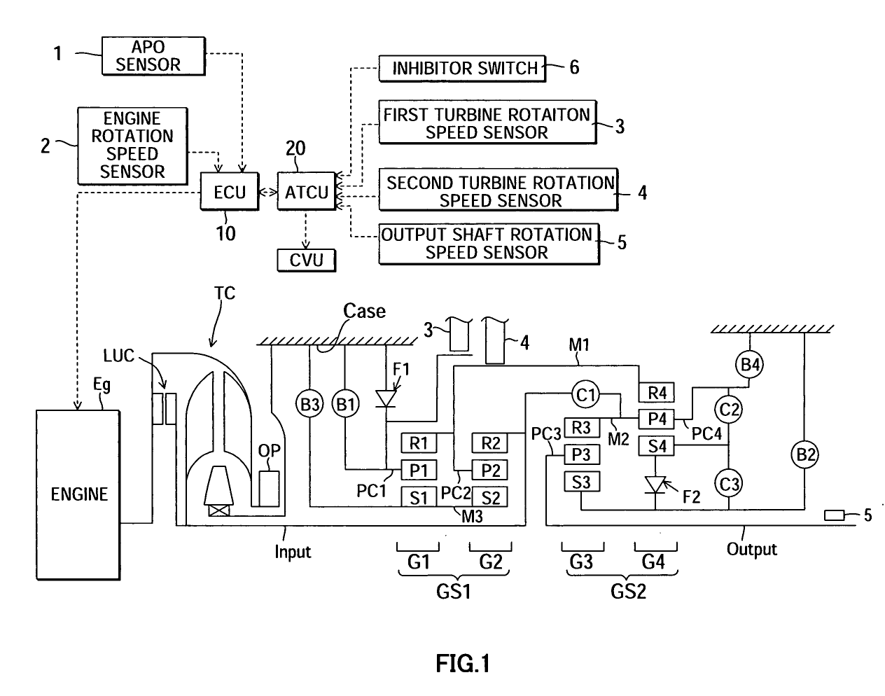

The constitution of an embodiment of this invention will be described below using FIG. 1. FIG. 1 is a skeleton diagram showing the constitution of an automatic transmission according to this embodiment. It should be noted that in this embodiment, a high gear position indicates a gear position having a small gear ratio, while a low gear position indicates a gear position having a large gear ratio.

The automatic transmission of this embodiment is a stepped automatic transmission having seven forward speeds and one reverse speed, in which a driving force of an engine Eg is input from an input shaft Input via a torque converter TC, whereupon a rotation speed is shifted by four planetary gears and seven friction engagement elements and output from an output shaft Output. Further, an oil pump OP is provided coaxially with a pump impeller of the torque converter TC and driven to rotate by the driving force of the engine Eg in order to pressurize oil.

An engine controller (ECU) 10 that controls a driving condition of the engine Eg, an automatic transmission controller (ATCU) 20 that controls a shift condition and so on of the automatic transmission, and a control valve unit CVU that controls an oil pressure of each engagement element on the basis of an output signal from the ATCU 20 are also provided. The ECU 10 and ATCU 20 are connected via a CAN communication line or the like, and communicate with each other to share sensor information and control information.

An APO sensor 1 that detects an accelerator pedal operation amount of a driver and an engine rotation speed sensor 2 that detects an engine rotation speed are connected to the ECU 10. The ECU 10 controls the rotation speed and torque of the engine by controlling a fuel injection amount and a throttle opening on the basis of the engine rotation speed and the accelerator pedal operation amount.

A first turbine rotation speed sensor 3 that detects a rotation speed of a first carrier PC1, a second turbine rotation speed sensor 4 that detects a rotation speed of a first ring gear R1, and an inhibitor switch 6 that detects a shift lever operating condition of the driver are connected to the ATCU 20. The ATCU 20 selects an optimum command gear position based on a vehicle speed Vsp and an accelerator pedal operation amount APO in a D range, and outputs a control command for achieving the command gear position to the control valve unit CVU.

Next, a shift gear mechanism that speed-shifts the rotation of the input shaft Input and transmits the speed-shifted rotation to the output shaft Output will be described. A first planetary gear set GS1 and a secondary planetary gear set GS2 are arranged in the shift gear mechanism in sequence from the input shaft Input side toward the output shaft Output side in an axial direction. Further, a plurality of clutches C1, C2, C3 and brakes B1, B2, B3, B4 are provided as the friction engagement elements, as well as a plurality of one-way clutches F1, F2.

A first planetary gear G1 is a single-pinion type planetary gear having a first sun gear S1, a first ring gear R1, and a first carrier PC1 supporting a first pinion P1 that is meshed to the two gears S1, R1. A second planetary gear G2 is a single-pinion type planetary gear having a second sun gear S2, a second ring gear R2, and a second carrier PC2 supporting a second pinion P2 that is meshed to the two gears S2, R2. A third planetary gear G3 is a single-pinion type planetary gear having a third sun gear S3, a third ring gear R3, and a third carrier PC3 supporting a third pinion P3 that is meshed to the two gears S3, R3. A fourth planetary gear G4 is a single-pinion type planetary gear having a fourth sun gear S4, a fourth ring gear R4, and a fourth carrier PC4 supporting a fourth pinion P4 that is meshed to the two gears S4, R4.

The input shaft Input is connected to the second ring gear R2 and inputs a rotary driving force from the engine Eg via the torque converter TC and so on. The output shaft Output is connected to the third carrier PC3 and transmits an output rotary driving force to a drive wheel via a final gear and so on.

A first connecting member M1 connects the first ring gear R1, the second carrier PC2, and the fourth ring gear R4 integrally. A second connecting member M2 connects the third ring gear R3 and the fourth carrier PC4 integrally. A third connecting member M3 connects the first sun gear S1 and the second sun gear S2 integrally.

The first planetary gear set GS1 is constituted by four rotary elements obtained by connecting the first planetary gear G1 to the second planetary gear G2 using the first connecting member M1 and the third connecting member M3. The second planetary gear set GS2 is constituted by five rotary elements obtained by connecting the third planetary gear G3 to the fourth planetary gear G4 using the second connecting member M2.

In the first planetary gear set GS1, torque is input into the second ring gear R2 from the input shaft Input, whereupon the input torque is output to the second planetary gear set GS2 via the first connecting member M1. In the second planetary gear set GS2, torque is input directly into the second connecting member M2 from the input shaft Input and into the fourth ring gear R4 via the first connecting member M1, whereupon the input torque is output to the output shaft Output from the third carrier PC3.

An input clutch C1 connects and disconnects the input shaft Input and the second connecting member M2 selectively. A direct clutch C2 connects and disconnects the fourth sun gear S4 and the fourth carrier PC4 selectively.

An H&LR clutch C3 connects and disconnects the third sun gear S3 and the fourth sun gear S4 selectively. Further, a second one-way clutch F2 is disposed between the third sun gear S3 and the fourth sun gear S4. Thus, when the H&LR clutch C3 is disengaged and the rotation speed of the fourth sun gear S4 is higher than that of the third sun gear S3, the third sun gear S3 and fourth sun gear S4 generate independent rotation speeds. As a result, the third planetary gear G3 and the fourth planetary gear G4 are connected via the second connecting member M2, and the respective planetary gears achieve independent gear ratios.

A front brake B1 stops the rotation of the first carrier PC1 selectively. Further, a first one-way clutch F1 is disposed parallel to the front brake B1. A low brake B2 stops the rotation of the third sun gear S3 selectively. A 2346 brake B3 stops the rotation of the third connecting member M3, which connects the first sun gear S1 to the second sun gear S2, selectively. A reverse brake B4 stops the rotation of the fourth carrier PC4 selectively.

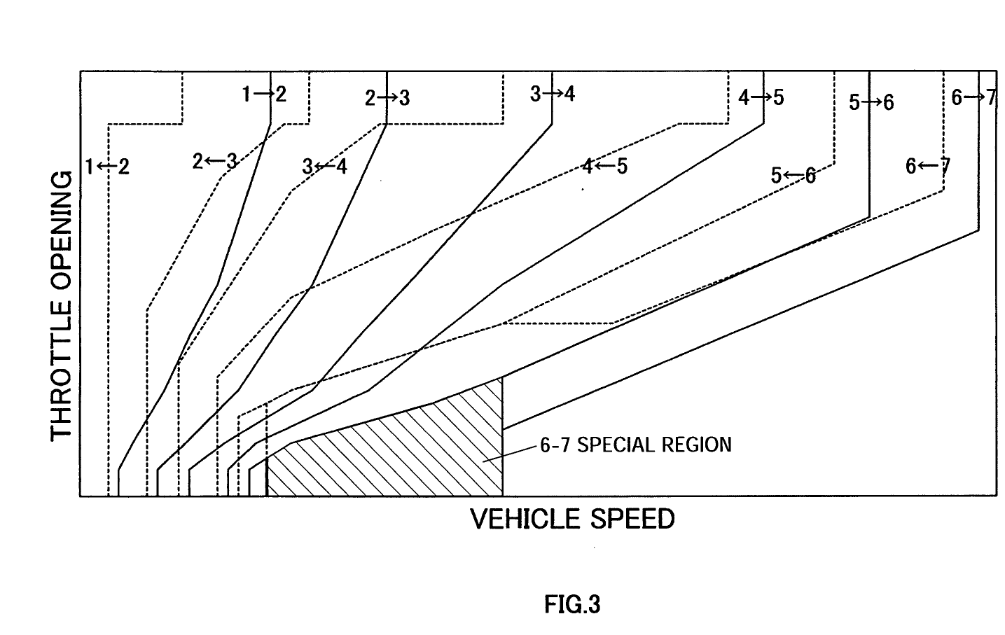

In the automatic transmission constituted as described above, a shift command is normally issued when a vehicle operating condition straddles a shift line on a shift map based on a relationship between the vehicle speed and the throttle opening, as shown in FIG. 3, for example, whereupon a shift is executed.

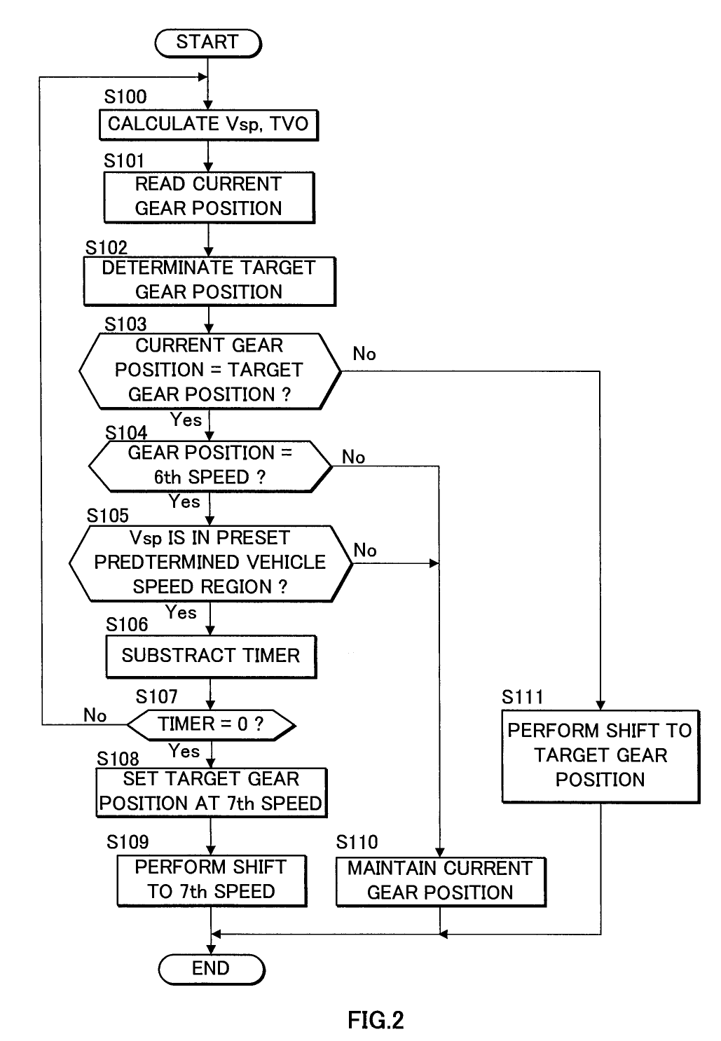

Next, shift control according to this embodiment will be described using the flowchart in FIG. 2.

In a step S100, the vehicle speed Vsp is calculated by the output shaft rotation speed sensor 5 and the accelerator pedal operation amount is detected by the APO sensor 1 to calculate a throttle opening TVO.

In a step S101, a current gear position is read in accordance with a signal from the ATCU 20.

In a step S102, a target gear position is determined from the shift map shown in FIG. 3 on the basis of the vehicle speed Vsp and the throttle opening TVO calculated in the step S100.

In a step S103, the current gear position is compared to the target gear position. When the current gear position and the target gear position match, the routine advances to a step S104, and when the current gear position and the target gear position are different, the routine advances to a step S111.

In the step S104, a determination is made as to whether or not the current gear position is one gear position lower than a maximum gear position, or in other words whether or not the current gear position is the gear position immediately to the low speed side of the maximum gear position. In this embodiment, the maximum gear position is a seventh speed gear position, and therefore a determination is made as to whether or not the current gear position is a sixth speed. When the gear position is the sixth speed, the routine advances to a step S105, and when the gear position is not the sixth speed, the routine advances to a step S110.

In the step S105, a determination is made as to whether or not the vehicle speed Vsp is in a preset predetermined vehicle speed region. In this embodiment, the predetermined vehicle speed region is a region extending from a minimum vehicle speed of a 7-6 downshift line on the shift map shown in FIG. 3, at which a downshift is performed from the seventh speed to the sixth speed, to a minimum vehicle speed of a 6-7 upshift line at which an upshift is performed from the sixth speed to the seventh speed. When the vehicle speed Vsp is in the predetermined vehicle speed region, the routine advances to a step S106, and when the vehicle speed Vsp is not in the predetermined vehicle speed region, the routine advances to the step S110.

In this embodiment, a determination is made in the steps S104 and S105 as to whether or not the relationship between the current vehicle speed Vsp and throttle opening TVO corresponds to a 6-7 special control region (predetermined region) shown in FIG. 3. The 6-7 special control region is set in the gear position region of the sixth speed on a high vehicle speed side of the 7-6 downshift line and on a low vehicle speed side of the minimum vehicle speed of the 6-7 upshift line. When the relationship between the current vehicle speed Vsp and throttle opening TVO is within the 6-7 special control region, the routine advances to the step S106, and when the relationship between the current vehicle speed Vsp and throttle opening TVO is not within the 6-7 special control region, the routine advances to the step S110.

In the step S106, 1 is subtracted from a previous timer value. In a case where the timer has been reset, 1 is subtracted from a predetermined time.

In a step S107, a determination is made as to whether or not the timer value subtracted in the step S106 is zero. In other words, a determination is made in the step S107 as to whether or not the operating condition has been in the 6-7 special operating region continuously for the predetermined time such that the vehicle operating condition corresponds to a cruising condition. When the timer value is zero, the routine advances to a step S108, and when the timer value is not zero, the routine returns to the step S100 to repeat the control described above. It should be noted that the predetermined time is a preset time period of a sufficient length to determine that the traveling condition of the vehicle corresponds to the cruising condition.

In the step S108, the current gear position is the sixth speed and the traveling condition of the vehicle corresponds to the cruising condition, and therefore the target gear position is set at the seventh speed. When the conditions of the steps S103 to S107 are satisfied, the target gear position is set at the seventh speed in order to perform a shift to the seventh speed, even though the vehicle operating condition corresponds to the sixth speed gear position on the shift map.

In a step S109, a shift is performed to the seventh speed, i.e. the maximum gear position. By performing a shift to the seventh speed, noise can be reduced during vehicle travel and an improvement in fuel efficiency can be achieved.

When it is determined in the step S104 that the current gear position is not the sixth speed gear position, or when it is determined in the step S105 that the current gear position is the sixth speed gear position but the vehicle speed is not in the predetermined vehicle speed region, i.e. when it is determined that the relationship between the vehicle speed Vsp and throttle opening TVO is not in the 6-7 special region, the current gear position is maintained in the step S110. Also, the timer is reset.

When it is determined in the step S103 that the current gear position and the target gear position are different, a shift is performed in the step S111 in accordance with the target gear position determined in the step S102.

Effects of this embodiment of the invention will now be described.

In this embodiment, when the vehicle speed Vsp and the throttle opening TVO have been in the 6-7 special region provided on the shift map continuously for the predetermined time, it is determined that the traveling condition of the vehicle corresponds to the cruising condition, and therefore a shift is performed to the seventh speed even though the shift map indicates the sixth speed. Thus, travel can be performed in the seventh speed even though the vehicle operating condition corresponds to the sixth speed region on the shift map, and therefore travel can be performed quietly and with improved fuel efficiency.

Furthermore, shift lines can be set on the shift map of a multi-step automatic transmission without making the intervals between the shift lines narrow, and as a result, a hunting phenomenon whereby upshifts and downshifts are performed repeatedly within a short time period can be suppressed. Moreover, the seventh speed region can be used, and therefore travel can be performed quietly and with improved fuel efficiency.

This application claims priority from Japanese Patent Application 2008-57962, filed Mar. 7, 2008, which is incorporated herein by reference in its entirety.

What is claimed is:

1. An automatic transmission having throttle opening detection unit that detects a throttle opening, vehicle speed detection unit that detects a vehicle speed, and shift unit that performs a shift on the basis of a shift map defined by the throttle opening and the vehicle speed, the automatic transmission comprising:
shift map region determination unit that determines whether or not the vehicle speed and the throttle opening exist within a predetermined region provided on a low vehicle speed side of a minimum vehicle speed of an upshift line at which a shift is performed to a maximum gear position of the shift map and on a high vehicle speed side of a minimum vehicle speed of a downshift line at which a shift is performed from the maximum gear position of the shift map to a lower gear position than the maximum gear position; and
cruising condition determination unit that determines whether or not an operating condition of a vehicle corresponds to a cruising condition,
wherein the shift unit performs a shift to the maximum gear position when the vehicle speed and the throttle opening are in the predetermined region and the operating condition corresponds to the cruising condition.

2. The automatic transmission as defined in claim 1, wherein the cruising condition determination unit determines that the operating condition corresponds to the cruising condition when the vehicle speed and the throttle opening have been in the predetermined region continuously for a predetermined time period.

3. The automatic transmission as defined in claim 1, wherein the lower gear position than the maximum gear position is a gear position one step to a low speed side of the maximum gear position.

4. The automatic transmission as defined in claim 3, wherein the predetermined region is a shift region one step to the low speed side of the maximum gear position on the shift map, and extends from a low vehicle speed side of a minimum vehicle speed of an upshift line at which a shift is performed from the gear position one step on the low speed side of the maximum gear position to the maximum gear position to a high vehicle speed side of a downshift line at which a shift is performed from the maximum gear position of the shift map to the gear position one step to the low speed side of the maximum gear position.

5. A control method for an automatic transmission having a throttle opening detection unit that detects a throttle opening, a vehicle speed detection unit that detects a vehicle speed, and a shift unit that performs a shift on the basis of a shift map defined by the throttle opening and the vehicle speed, the control method comprising:
determining whether or not the vehicle speed and the throttle opening exist within a predetermined region provided on a low vehicle speed side of a minimum vehicle speed of an upshift line at which a shift is performed to a maximum gear position of the shift map and on a high vehicle speed side of a minimum vehicle speed of a downshift line at which a shift is performed from the maximum gear position of the shift map to a lower gear position than the maximum gear position;
determining whether or not an operating condition of a vehicle corresponds to a cruising condition; and
performing a shift to the maximum gear position when the vehicle speed and the throttle opening are in the predetermined region and the operating condition corresponds to the cruising condition.

6. The control method for the automatic transmission as defined in claim 5, wherein the operating condition corresponds to the cruising condition when the vehicle speed and the throttle opening have been in the predetermined region continuously for a predetermined time period.

7. The control method for the automatic transmission as defined in claim 5, wherein the lower gear position than the maximum gear position is a gear position one step to a low speed side of the maximum gear position.

8. The control method for the automatic transmission as defined in claim 7, wherein the predetermined region is a shift region one step to the low speed side of the maximum gear position on the shift map, and extends from a low vehicle speed side of a minimum vehicle speed of an upshift line at which a shift is performed from the gear position one step on the low speed side of the maximum gear position to the maximum gear position to a high vehicle speed side of a downshift line at which a shift is performed from the maximum gear position of the shift map to the gear position one step to the low speed side of the maximum gear position.

9. An automatic transmission having a throttle opening detection means that detects a throttle opening, a vehicle speed detection means that detects a vehicle speed, and a shift means that performs a shift on the basis of a shift map defined by the throttle opening and the vehicle speed, the automatic transmission comprising:
a shift map region determination means that determines whether or not the vehicle speed and the throttle opening exist within a predetermined region provided on a low vehicle speed side of a minimum vehicle speed of an upshift line at which a shift is performed to a maximum gear position of the shift map and on a high vehicle speed side of a minimum vehicle speed of a downshift line at which a shift is performed from the maximum gear position of the shift map to a lower gear position than the maximum gear position; and
a cruising condition determination means that determines whether or not an operating condition of a vehicle corresponds to a cruising condition,
wherein the shift means performs a shift to the maximum gear position when the vehicle speed and the throttle opening are in the predetermined region and the operating condition corresponds to the cruising condition.

10. The automatic transmission as defined in claim 9, wherein the cruising condition determination means determines that the operating condition corresponds to the cruising condition when the vehicle speed and the throttle opening have been in the predetermined region continuously for a predetermined time period.

11. The automatic transmission as defined in claim 9, wherein the lower gear position than the maximum gear position is a gear position one step to a low speed side of the maximum gear position.

12. The automatic transmission as defined in claim 11, wherein the predetermined region is a shift region one step to the low speed side of the maximum gear position on the shift map, and extends from a low vehicle speed side of a minimum vehicle speed of an upshift line at which a shift is performed from the gear position one step on the low speed side of the maximum gear position to the maximum gear position to a high vehicle speed side of a downshift line at which a shift is performed from the maximum gear position of the shift map to the gear position one step to the low speed side of the maximum gear position.
